(19) United States
(12) Patent Application Publication
(10) Pub. No.: US 2007/0279445 A1
(43) Pub. Date: Dec. 6, 2007

(54) Recording Apparatus

(75) Inventor: Yoshiteru Yamashita, Tsushima-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/757,857

(22) Filed: Jun. 4, 2007

(30) Foreign Application Priority Data
Jun. 6, 2006 (JP) 2006-157379

(51) Int. Cl. B41J 29/38

(52) U.S. Cl. 347/17

(57) ABSTRACT

A recording apparatus includes a conveyor mechanism, a recording head, a stopper, a restarter, and a conveyance controller. The conveyor mechanism has a conveyor belt and a driver driving the belt. The recording head has a head main body, a driver IC driving the head main body, and a temperature sensor detecting a temperature of the driver IC. The stopper stops driving of the driver IC in a case where the temperature sensor has detected a temperature equal to or higher than a predetermined maximum temperature. The restarter restarts driving of the driver IC in a case where, after the stopper stops driving of the driver IC, the temperature sensor has detected a temperature equal to or lower than a predetermined restart temperature. The conveyance controller controls the driver so as to keep driving the belt while driving of the driver IC is being stopped by the stopper.

### BACKGROUND OF THE INVENTION

1. Field of the Invention

The present invention relates to a recording apparatus that records an image on a recording medium.

2. Description of Related Art

As an ink-jet printer that ejects ink droplets to a paper as a recording medium to thereby record an image on the paper, there is known an ink-jet printer having a recording head that includes a passage unit and an actuator, and a driver IC that generates a pulse drive signal used for driving the actuator. The passage unit includes a plurality of nozzles that eject ink droplets, and pressure chambers that communicate with the respective nozzles. The actuator gives ejection energy to ink contained in a pressure chamber, by changing a volume of the pressure chamber. The actuator has a piezoelectric sheet, individual electrodes, and a common electrode. The piezoelectric sheet extends over pressure chambers. The individual electrodes are opposed to the respective pressure chambers. The common electrode is opposed to the individual electrodes across the piezoelectric sheet. The common electrode is given a reference potential. When a pulse drive signal is given from the driver IC to an individual electrode, the actuator is driven.

A high-speed printing is now demanded of an ink-jet printer. In order to eject ink droplets in a shorter cycle for the purpose of high-speed printing, a drive signal outputted by a driver IC mush have a higher pulse frequency. If drive signals of high pulse frequencies are continuously output, the driver IC generates a large amount of heat. Japanese Unexamined Patent Publication No. 2005-22294 discloses that, in order to prevent thermal destruction of a driver IC, when a temperature of the driver IC becomes equal to or higher than a predetermined maximum temperature, driving of the driver IC and paper conveyance performed by a conveyor belt are stopped to cool down the driver IC, while, after the temperature of the driver IC drops to a predetermined restart temperature, driving of the driver IC and paper conveyance performed by the conveyor belt are started again.

### SUMMARY OF THE INVENTION

In the above-mentioned technique, however, the driver IC is cooled down naturally until it reaches the restart temperature. Therefore, depending on ambient atmosphere, printing may be kept stopped for a long time. As a result, a printing speed may be lowered on the contrary. Thus, speedup of printing, which is an original object, cannot be sufficiently attained.

The present invention may provide a recording apparatus that realizes speedup of printing.

According to an aspect of the present invention, there is provided a recording apparatus comprising a conveyor mechanism, a recording head, a stopper, a restarter, and a conveyance controller. The conveyor mechanism has a plurality of rollers, an endless conveyor belt that is stretched between the rollers and holds a recording medium on its outer circumferential surface, and a driver that drives the conveyor belt. The recording head has a head main body that forms an image on the recording medium conveyed by the conveyor mechanism, a driver IC that drives the head main body, and a temperature sensor that detects a temperature of the driver IC. The stopper stops driving of the driver IC in a case where the temperature sensor has detected a temperature equal to or higher than a predetermined maximum temperature. The restarter restarts driving of the driver IC in a case where, after the stopper stops driving of the driver IC, the temperature sensor has detected a temperature equal to or lower than a predetermined restart temperature. The conveyance controller controls the driver so as to keep driving the conveyor belt while driving of the driver IC is being stopped by the stopper.

According to the above aspect, while recording on a recording medium is being stopped by the stopper because a temperature of the driver IC is equal to or higher than the maximum temperature, the conveyor belt is kept driven to thereby cause an airflow around the recording head, so that the driver IC is efficiently cooled down. As a consequence, in order to cool down the driver IC, recording has to be stopped for a shorter period of time. Therefore, speedup of recording can be realized.

### BRIEF DESCRIPTION OF THE DRAWINGS

Other and further objects, features and advantages of the invention will appear more fully from the following description taken in connection with the accompanying drawings in which:

FIG. 1 schematically shows a side view of an ink-jet printer according to an embodiment of the present invention;

FIG. 2 is a top view of a part of the ink-jet printer;

FIG. 3 shows a cross section of an ink-jet head shown in FIG. 1, as sectioned along a widthwise direction thereof;

FIG. 4 is a plan view of a head main body shown in FIG. 3;

FIG. 5 shows on an enlarged scale a region enclosed by an alternate long and short dash line in FIG. 4;

FIG. 6 shows a cross section taken along line VI-VI in FIG. 5;

FIG. 7A shows on an enlarged scale a region enclosed by an alternate long and short dash line in FIG. 6;

FIG. 7B is a top view of FIG. 7A;

FIG. 8 is a block diagram showing an electrical construction of the ink-jet printer;

FIG. 9 is a flowchart of an operation of a control unit shown in FIG. 1;

FIG. 10 is a graph showing how a temperature of a driver IC changes during continuous printing on several papers; and

FIG. 11 is a top view of a conveyor belt according to a modification.

### DESCRIPTION OF THE PREFERRED EMBODIMENTS

In the following, a certain preferred embodiment of the present invention will be described with reference to the accompanying drawings.

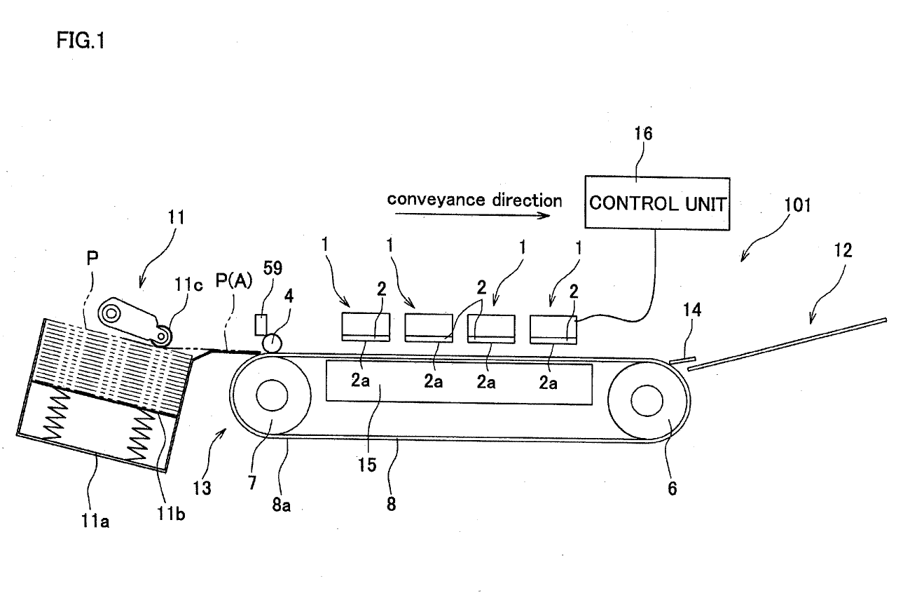

FIG. 1 schematically shows a side view of an ink-jet printer 101 according to an embodiment of the present invention. The ink-jet printer 101 is a color ink-jet printer of line type, having four immovable ink-jet heads 1. The ink-jet printer 101 has a control unit 16 that controls a total operation of the ink-jet printer 101. The ink-jet printer 101 includes a paper feed unit 11 and a paper discharge tray 12, which are shown in left and right parts of FIG. 1, respectively. Formed within the ink-jet printer 101 is a path through which a paper P is conveyed from the paper feed unit 11 toward the paper discharge tray 12.

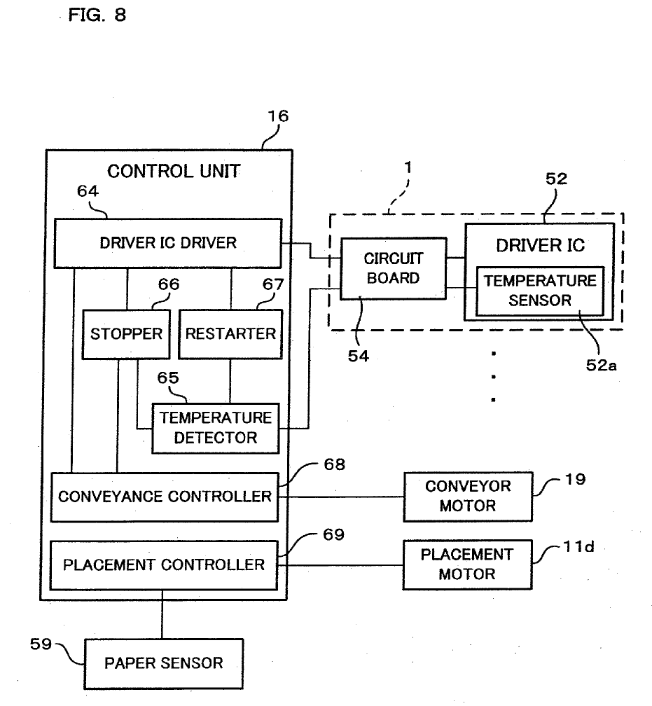

The paper feed unit 11 has a paper stocker 11a and a pick-up roller 11c. The paper stocker 11a has a box shape provided with an opening in an upper portion thereof. The paper stocker 11a is disposed in such a manner that it is inclined rightward in FIG. 1, that is, toward a downstream in a conveyance direction. A supporting plate 11b is disposed within the paper stocker 11a. The supporting plate 11b is biased from a bottom to the opening of the paper stocker 11a. A pile of papers P is placed on the supporting plate 11b. The pick-up roller 11c, which is driven by a placement motor 11d (see FIG. 8), picks up upper one of the papers P stacked in the paper stocker 11a, and sends out the picked-up paper P toward the downstream in the conveyance direction.

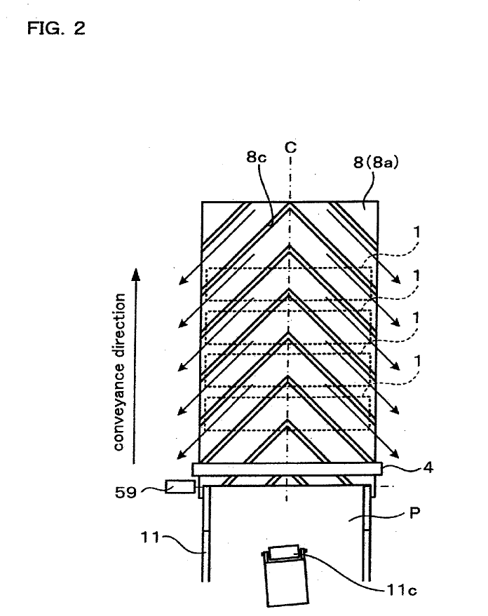

A paper sensor 59 is disposed immediately downstream of the paper feed unit 11. The paper sensor 59 detects whether a paper P sent out by the pick-up roller 11c has reached a printing standby position A or not. The printing standby position A locates immediately upstream of the conveyor belt 8. The paper sensor 59 is adjusted so as to detect a leading edge of the paper P locating at the printing standby position A (see FIG. 2). The paper P sent out of the paper stocker 11a by the pick-up roller 11c passes through the printing standby position A, and is placed onto an outer circumferential surface 8a of the conveyor belt 8.

A conveyor mechanism 13 is provided in a middle of the paper conveyance path. The conveyor mechanism 13 includes two belt rollers 6 and 7, an endless conveyor belt 8, a conveyor motor 19 (see FIG. 8), and a platen 15. The conveyor belt 8 is wound on the rollers 6 and 7 so as to be stretched between the rollers 6 and 7. The conveyor motor 19 makes the belt roller 6 rotate. The platen 15 is disposed in a region enclosed by the conveyor belt 8, so as to be opposed to the ink-jet heads 1. The platen 15 supports the conveyor belt 8 to prevent a portion of the conveyor belt 8 opposed to the ink-jet heads 1 from being bent downward. A nip roller 4 is disposed at a position opposed to the belt roller 7. When a paper P is placed onto the outer circumferential surface 8a of the conveyor belt 8 by the pick-up roller 11c, then the nip roller 4 presses the paper P to the outer circumferential surface 8a. When the conveyor motor 19 (see FIG. 8) makes the belt roller 6 rotate, the conveyor belt 8 is driven. The conveyor belt 8 conveys the paper P, which has been pressed to the outer circumferential surface 8a by the nip roller 4, toward the paper discharge tray 12 while keeping the paper P by its adhesive force.

As shown in FIG. 2, a plurality of grooves 8c are formed in the conveyance direction on the outer circumferential surface 8a of the conveyor belt 8. The groove 8c is a V-shaped groove that extends, in an oblique direction against the conveyance direction, from a widthwise center C to both widthwise ends of the conveyor belt 8. The groove 8c extends from one widthwise end to the other widthwise end of the conveyor belt 8. When the conveyor belt 8 is driven, the grooves 8c move in the conveyance direction. Here, the grooves 8c extend from the center C in the oblique direction against the conveyance direction. Consequently, an airflow, which flows from the vicinity of the center C toward the both widthwise ends of the conveyor belt 8, occurs around the ink-jet heads 1, as indicated by arrows in FIG. 2. In FIG. 2, for convenience of explanation, the ink-jet heads 1 are illustrated with broken lines though they should actually be illustrated with solid lines.

Referring to FIG. 1 again, a peeling plate 14 is provided immediately downstream of the conveyor belt 8. The peeling plate 14 peels a paper P, which has been kept on the outer circumferential surface 8a of the conveyor belt 8, from the outer circumferential surface 8a, and then sends the paper P to the paper discharge tray 12.

The four ink-jet heads 1 are arranged along the conveyance direction. Each ink-jet head 1 has, at its lower end, a head main body 2 of rectangular parallelepiped shape elongated in a direction perpendicular to the conveyance direction, that is, elongated in a direction perpendicularly crossing the drawing sheet in FIG. 1. A bottom face of the head main body 2 serves as an ink ejection face 2a that is opposed to the outer circumferential surface 8a of the conveyor belt 8. From ink ejection faces 2a of the four head main bodies 2, ink droplets of four different colors of magenta, yellow, cyan, and black are respectively ejected. While a paper P conveyed on the conveyor belt 8 is passing just under the four head main bodies 2, ink droplets of respective colors are ejected from the ink ejection faces 2a toward an upper face of the paper P, so that a desired color image is formed on the paper P.

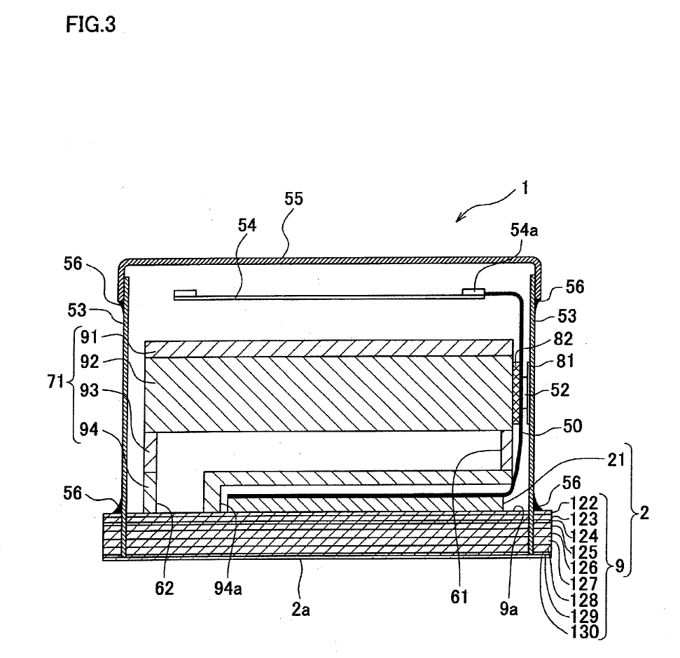

Next, the ink-jet head 1 will be described in detail with reference to FIG. 3.

As shown in FIG. 3, the ink-jet head 1 has a head main body 2, a reservoir unit 71 disposed on an upper face of the head main body 2, a Chip On Film (COF) 50, a circuit board 54 electrically connected to the COF 50, side covers 53, and a head cover 55. The head main body 2 includes a passage unit 9 and an actuator unit 21. The reservoir unit 71 supplies ink to the head main body 2. A driver IC 52 is mounted on a surface of the COF 50. The driver IC 52 generates a drive signal that drives the actuator unit 21. Based on a command from the control unit 16 (see FIG. 1), the circuit board 54 makes the driver IC 52 output a drive signal to the actuator unit 21. The side covers 53 and the head cover 55 cover the actuator unit 21, the reservoir unit 71, the COF 50, and the circuit board 54, to prevent intrusion of ink or ink mist from outside.

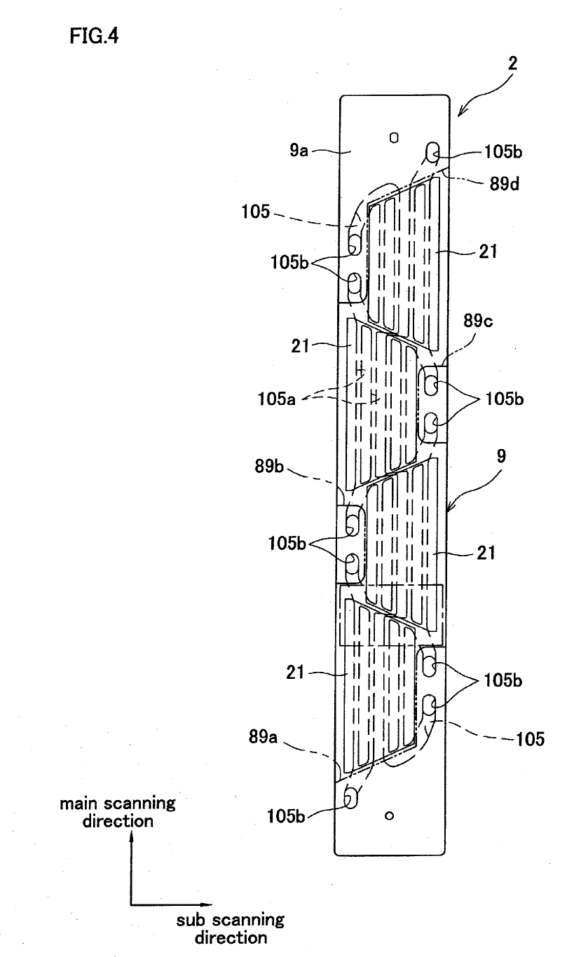

The reservoir unit 71 has four metallic plates 91 to 94 positioned with and layered on one another. An ink inflow passage (not shown), an ink reservoir 61, and ten ink outflow passages 62 (only one of which is shown in FIG. 3) are formed within the reservoir unit 71. Ink supplied from an ink tank (not shown) flows into the ink inflow passage. The ink reservoir 61 communicates with the ink inflow passage and the ink outflow passages 62. The ink outflow passages 62 communicate with the passage unit 9 respectively through ten ink supply ports 105b that are formed on an upper face 9a of the passage unit 9 (see FIG. 4). The reservoir unit 71 and the passage unit 9 are connected in this way, so that they are thermally coupled with each other. Ink supplied from the ink tank flows into the ink inflow passage, and then is temporarily stored in the ink reservoir 61. Ink stored in the ink reservoir 61 passes through the ink outflow passages 62, to be supplied through the ink supply ports 105b to the passage unit 9.

As shown in FIG. 3, a recess 94a is formed on a lower face of the plate 94. There is a space between the passage unit 9 and a bottom of the recess 94a. The actuator unit 21 is positioned on the upper face 9a of the passage unit 9 so as to be opposed to the recess 94a. The actuator unit 21 is fixed to the upper face 9a of the passage unit 9, so that a space much larger than a thickness of the COF 50 is formed between the passage unit 9 and the bottom of the recess 94a.

The COF 50 is, in its portion near one end, bonded to an upper face of the actuator unit 21 in such a manner that wires (not shown) formed on a surface of the COF 50 are electrically connected to individual electrodes 135 and a common electrode 134 which will be described later. The COF 50 extends from the upper face of the actuator unit 21 upward through a space between the side cover 53 and the reservoir unit 71, to have the other end thereof connected to the circuit board 54 through the connector 54a.

The driver IC 52 outputs a drive signal through a wire of the COF 50 to each individual electrode 135 of the actuator unit 21. The driver IC 52 has a temperature sensor 52a (see FIG. 8) that detects a temperature of the driver IC 52. A sponge 82 that is bonded to a side face of the reservoir unit 71 biases the driver IC 52 to the side cover 53. The driver IC 52 is in tight contact with an inner face of the side cover 53 with interposition of a dissipation sheet 81. Thereby, the driver IC 52 is thermally coupled with the side cover 53.

The side covers 53, which are metallic plate members, extend along a lengthwise direction of the passage unit 9 and also extend upward from both widthwise end portions of the upper face 9a of the passage unit 9. A lower end of the side cover 53 is engaged with a groove formed in the passage unit 9. Thus, the side cover 53 and the passage unit 9 are thermally coupled with each other. As described above, the driver IC 52 and the side cover 53 are thermally coupled, and in addition the reservoir unit 71 and the passage unit 9 are thermally coupled. Consequently, the driver IC 52, the side cover 53, the passage unit 9, and the reservoir unit 71 are thermally coupled.

The head cover 55 is fixed to upper ends of the two side covers 53 so as to span them, thereby sealing a space above the passage unit 9. The reservoir unit 71, the COF 50, and the circuit board 54 are disposed within a space that is enclosed by the two side covers 53 and the head cover 55. Sealing members 56 made of a silicon resin or the like are applied to where the side cover 53 and the passage unit 9 are connected to each other, and where the side cover 53 and the head cover 55 are fitted to each other. Thereby, intrusion of ink or ink mist from outside is more surely prevented.

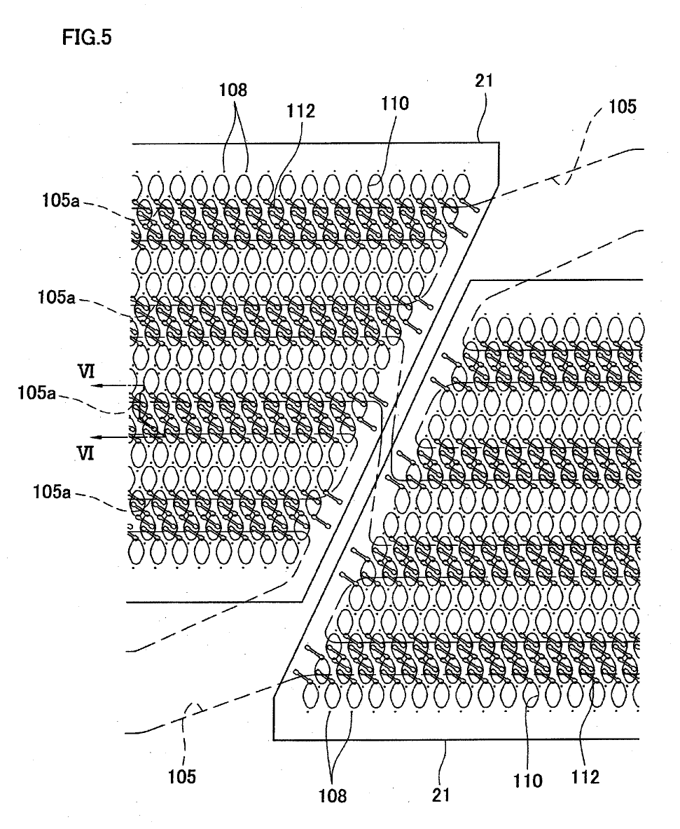

Next, the head main body 2 will be described with reference to FIGS. 4, 5, 6, 7A, and 7B. In FIG. 5, for convenience of explanation, pressure chambers 110, apertures 112, and nozzles 108 are illustrated with solid lines although they locate below the actuator units 21 and therefore should actually be illustrated with broken lines.

As shown in FIG. 4, the head main body 2 includes a passage unit 9 and four actuator units 21 fixed to an upper face 9a of the passage unit 9.

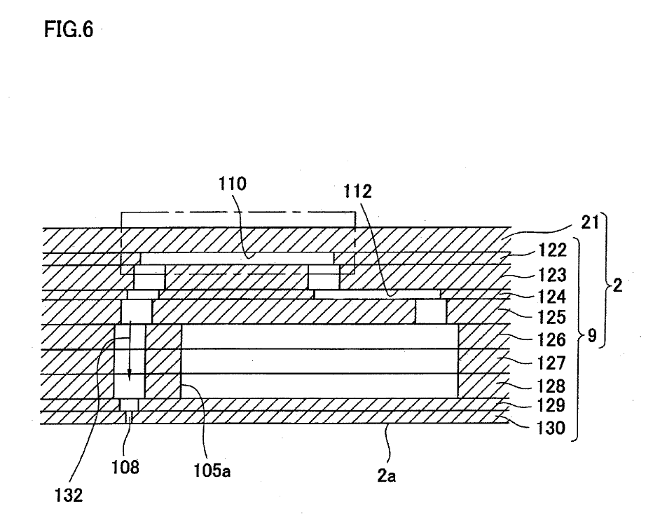

The passage unit 9 has a rectangular parallelepiped shape. In a plan view, a shape the passage unit 9 is substantially the same as a shape of the plate 94 of the reservoir unit 71. A total of ten ink supply ports 105b are opened on the upper face 9a of the passage unit 9. The ten ink supply ports 105b correspond to the ink outflow passages 62 of the reservoir unit 71 (see FIG. 3). Formed within the passage unit 9 are manifold channels 105 that communicate with the ink supply ports 105b and sub manifold channels 105a that branch from the manifold channels 105, as shown in FIGS. 4 and 5. On the upper face 9a of the passage unit 9, as shown in FIGS. 5 and 6, a plurality of pressure chambers 110 are formed in a matrix in a region corresponding to each actuator unit 21. A region of a lower face of the passage unit 9, which means a region of the ink ejection face 2a, corresponding to each actuator unit 21 is an ink ejection region where a plurality of nozzles 108 are arranged in a matrix so as to correspond to the respective pressure chambers 110.

In this embodiment, as shown in FIG. 5, in a region corresponding to one actuator unit, there are sixteen pressure chamber rows each extending in a lengthwise direction of the passage unit 9 and each made up of a plurality of pressure chambers 110 that are arranged at regular intervals. The number of pressure chambers 110 included in each pressure chamber row is gradually reduced from a longer side to a shorter side of a trapezoidal shape of the actuator unit 21. Nozzles 108 are arranged in the same manner, too.

As shown in FIG. 6, the passage unit 9 includes nine metal plates such as stainless steel plates, namely, from the top, a cavity plate 122, a base plate 123, an aperture plate 124, a supply plate 125, manifold plates 126, 127, 128, a cover plate 129, and a nozzle plate 130. In a plan view, each of the plates 122 to 130 has a rectangular shape elongated in the main scanning direction. Holes which will constitute individual ink passages 132 are formed through the respective plates 122 to 130. The plates 122 to 130 are positioned in layers, so that a plurality of individual ink passages 132 are formed within the passage unit 9. Each of the individual ink passages 132 extends from a manifold channel 105 to a nozzle 108 through a sub manifold channel 105a, an outlet of the sub manifold channel 105a, an aperture 112, and a pressure chamber 110.

As shown in FIGS. 4 to 6, ink supplied from the reservoir unit 71 through the ink supply ports 105b into the passage unit 9 are branched from the manifold channels 105 into the sub manifold channels 105a. Ink in the sub manifold channels 105a flows into the respective individual ink passages 132, and reaches the nozzles 108 through apertures 112 acting as throttle and pressure chambers 110.

The actuator units 21, each of which has a trapezoidal shape in a plan view, are arranged so as to keep away from the ink supply ports 105b. The actuator units 21 are formed in two rows and in a zigzag pattern along the lengthwise direction of the passage unit 9. The actuator unit 21 includes actuators each corresponding to each pressure chamber 110, and selectively gives ejection energy to ink contained in the pressure chambers 110. As shown in FIG. 4, parallel opposed sides of each actuator unit 21 extend along the lengthwise direction of the passage unit 9. Oblique sides of every neighboring actuator units 21 overlap each other with respect to a widthwise direction of the passage unit 9, that is, with respect to the sub scanning direction.

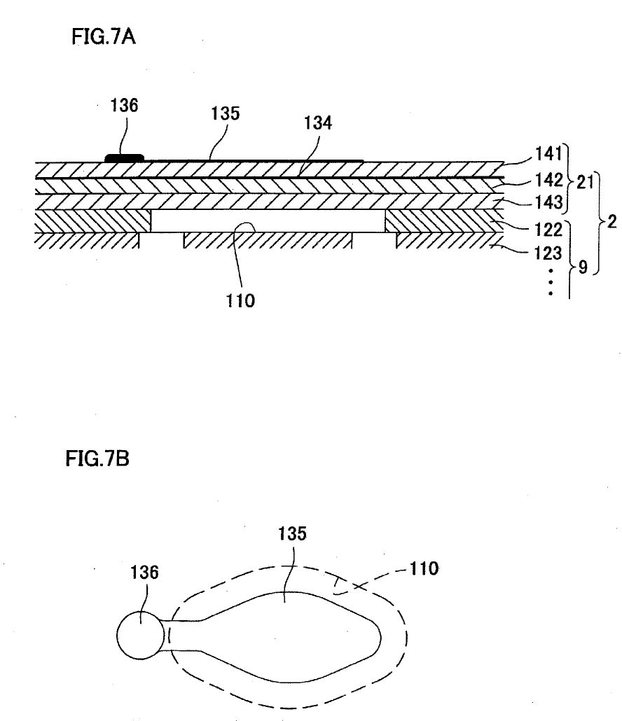

As shown in FIG. 7A, the actuator unit 21 includes three piezoelectric sheets 141, 142, and 143 made of a lead zirconate titanate (PZT)-base ceramic material having ferroelectricity. On the uppermost piezoelectric sheet 141, an individual electrode 135 is formed at a position opposed to each pressure chamber 110. A common electrode 134 is interposed between the piezoelectric sheet 141 and the piezoelectric sheet 142 positioned under the piezoelectric sheet 141. The common electrode 134 is formed over an entire surface of the sheet. As shown in FIG. 7B, the individual electrode 135 has a substantially rhombic planar shape similar to but slightly smaller than the pressure chamber 110. In a plan view, a large part of the individual electrode 135 falls within the pressure chamber 110. The substantially rhombic individual electrode 135 has its one acute portion extending out beyond the pressure chamber 110, and a circular land 136 is provided on a distal end of an extending-out portion thus formed. The land 136 is electrically bonded to the individual electrode 135.

The common electrode 134 is, in its portions corresponding to all the pressure chambers 10, equally kept at the ground potential. Each individual electrode 135 is electrically connected to each terminal of the driver IC 52 through a land 136 and an internal wire of the COF 50. A drive signal from the driver IC 52 is selectively input to the individual electrode 135. A portion of the actuator unit 21 sandwiched between an individual electrode 135 and a pressure chamber 110 acts as an individual actuator. That is, the number of actuators formed within the actuator unit 21 corresponds to the number of pressure chambers 110.

Here, how the actuator unit 21 drives will be described. The piezoelectric sheet 141 is polarized in its thickness direction. When an individual electrode 135 is set at a potential different from a potential of the common electrode 134, an electric field in a polarization direction is applied to an active portion of the piezoelectric sheet 141 which is sandwiched between the individual electrode 135 and the common electrode 134. As a result, due to a transversal piezoelectric effect, the active portion of the piezoelectric sheet 141 contracts in a direction perpendicular to the polarization direction, that is, in a plane direction. The other piezoelectric sheets 142 and 143 do not deform by themselves because they are not affected by the electric field. Consequently, a difference occurs between plane-direction distortion of the upper piezoelectric sheet 141 and plane-direction distortion of the lower piezoelectric sheets 142 and 143, so that the piezoelectric sheets 141 to 143 as a whole deform protrudingly toward a pressure chamber 110 (unimorph deformation). To be more specific, the actuator unit 21 is of so-called unimorph type, in which the piezoelectric sheet 141 most distant from the pressure chambers 110 acts as a layer including active portions while the lower two piezoelectric sheets 142 and 143 closer to the pressure chambers 110 act as inactive layers. Here, the piezoelectric sheets 141 to 143 are fixed to an upper face of the cavity plate 122 that partitions the pressure chambers 110 as shown in FIG. 7A. As a result, a region of the piezoelectric sheets 141 to 143 corresponding to an active portion deforms protrudingly toward a pressure chamber 110.

In this embodiment, the driver IC 52 outputs a drive signal such that a predetermined potential has been given to an individual electrode 135 beforehand, and that the ground potential is given to the individual electrode 135 upon every ejection request and then at a predetermined timing the predetermined potential is given to the individual electrode 135 again. In such a case, in an initial state, a region of the piezoelectric sheets 141 to 143 corresponding to an active portion already deforms protrudingly toward a pressure chamber 110. When an ejection request is issued, at a timing of giving the ground potential to the individual electrode 135, the piezoelectric sheets 141 to 143 become flat so that a volume of the pressure chamber 110 becomes larger than in the initial state. Pressure of ink contained in the pressure chamber 110 drops accordingly, and therefore ink is sucked from a sub manifold channel 105a into an individual ink passage 132. Then, at a timing of giving the predetermined potential again to the individual electrode 135, the region of the piezoelectric sheets 141 to 143 corresponding to the active portion deforms protrudingly toward the pressure chamber 110 so that the volume of the pressure chamber 110 is reduced. This applies pressure, that is, ejection energy, to ink contained in the pressure chamber 110, thus causing a pressure wave in the pressure chamber 110. The pressure wave propagates from the pressure chamber 110 to a nozzle 108, to thereby eject an ink droplet from the nozzle 108.

Next, an electrical construction of the ink-jet printer 101 will be described in detail with reference to FIG. 8. FIG. 8 schematically illustrates only one of the four ink-jet heads 1. The control unit 16 has a driver IC driver 64, a temperature detector 65, a stopper 66, a restarter 67, a conveyance controller 68, and a placement controller 69.

The driver IC driver 64 drives, through the circuit board 54, the driver IC 52 of each ink-jet head 1 in such a manner that a desired image is formed on a paper P. At this time, printing on one paper P is one unit of driving operation. In such a condition, the driver IC driver 64 drives the driver IC 52.

Based on a result of output from temperature sensors 52a of the respective driver ICs 52, the temperature detector 65 detects a temperature T of the driver IC 52 having the highest temperature.

When the temperature detector 65 detects a temperature T that is equal to or higher than a predetermined maximum temperature Toff (150 degrees C. for example), in order to prevent thermal destruction of the driver IC 52, the stopper 66 stops the driver IC driver 64 from driving the driver IC 52 in a condition that one unit of driving operation of the driver IC 52 has been completed, in other words, in a condition that printing on one paper P has been completed. Here, the maximum temperature Toff is set to be lower than a temperature at which thermal destruction of the driver IC 52 occurs.

When, after the stopper 66 stops the driver IC driver 64 from driving the driver IC 52, a temperature T detected by the temperature detector 65 reaches a predetermined restart temperature Ton (120 degrees C. for example) or lower, the restarter 67 restarts the driver IC driver 64 driving the driver IC 52.

The conveyance controller 68 controls driving of the conveyor belt 8 by controlling the conveyor motor 19. While the stopper 66 is not stopping driving of the driver IC 52, the conveyance controller 68 controls the conveyor motor 19 so as to make the conveyor belt 8 driven at a printing speed, that is, so as to make the conveyor belt 8 driven in a normal mode. While the stopper 66 is stopping driving of the driver IC 52, the conveyance controller 68 controls the conveyor motor 19 so as to make the conveyor belt 8 driven at a speed higher than in the normal mode, that is, so as to make the conveyor belt 8 driven at high speed.

The placement controller 69 controls driving of the pick-up roller 11c by controlling the placement motor 11d. Based on a result of output from the paper sensor 59, the placement controller 69 determines whether a paper P sent out by the pick-up roller 11c has reached the printing standby position A (see FIG. 1) or not. When the paper P has reached the printing standby position A, the placement controller 69 once stops driving of the pick-up roller 11c. At this time, in a case where the driver IC 52 is stopped by the stopper 66, the paper P is kept at the printing standby position A until the restarter 67 restarts driving of the driver IC 52.

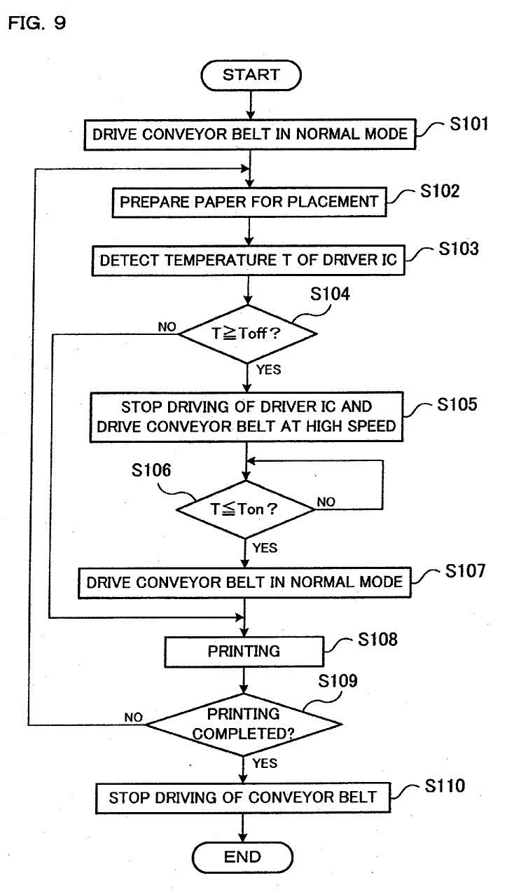

Next, an operation of the control unit 16 will be described with reference to FIG. 9.

As a print command is issued, first, the conveyance controller 68 drives the conveyor belt 8 in the normal mode (S101). Then, the placement controller 69 controls driving of the pick-up roller 11c so as to place the paper P, which has been sent out of the paper stocker 11a, at the printing standby position A (S102) Then, based on a result of output from the temperature sensor 52a of each driver IC 52, the temperature detector 65 detects a temperature T of the driver IC 52 having the highest temperature (S103).

After S103, the stopper 66 determines whether the temperature detector 65 has detected a temperature T equal to or higher than the maximum temperature Toff or not (S104). When the temperature detector 65 has not detected a temperature T equal to or higher than the maximum temperature Toff (S104: NO), the processing proceeds to S108. When the temperature detector 65 has detected a temperature T equal to or higher than the maximum temperature Toff (S104: YES), the stopper 66 stops the driver IC driver 64 from driving the driver IC 52 and in addition the conveyance controller 68 drives the conveyor belt 8 at high speed (S105). Then, the restarter 67 determines whether a temperature T of the driver IC 52 detected by the temperature detector 65 has become equal to or lower than the restart temperature Ton or not (S106). When the temperature T has become equal to or lower than the restart temperature Ton (S106: YES), the conveyance controller 68 drives the conveyor belt 8 in the normal mode (S107). Then, the processing proceeds to S108.

When the temperature T has not become equal to or lower than the restart temperature Ton (S106: NO), the control unit 16 waits until the temperature T become equal to or lower than the restart temperature Ton. During this period, the conveyor belt 8 is driven at high speed. Therefore, air strongly flows above the outer circumferential surface 8a of the conveyor belt 8, from the vicinity of the center C to the both widthwise ends of the conveyor belt 8 (see FIG. 2). As a result, air existing around the passage unit 9 of the ink-jet head 1, which is opposed to the outer circumferential surface 8a, flows especially strongly, so that the passage unit 9 is cooled rapidly. Since the passage unit 9 is thermally coupled with the driver I 52, heat of the driver IC 52 is dissipated through the passage unit 9 as well.

In S108, in a case where the driver IC 52 is stopped by the stopper 66, the restarter 67 restarts driving of the driver IC 52 and then a next paper P is subjected to printing. At this time, the placement controller 69 controls driving of the pick-up roller 11c so as to place a paper P, which is waiting at the printing standby position A, onto the outer circumferential surface 8a of the conveyor belt 8. Then, whether all printing has been completed or not is determined (S109). When printing has not been completed (S109: NO), the processing returns to S102 and the above-described procedures are repeated for a next paper P. When printing has been completed (S109: YES), the conveyance controller 68 stops driving of the conveyor belt 8 (S110). Then, the processing shown by the flowchart in FIG. 9 ends.

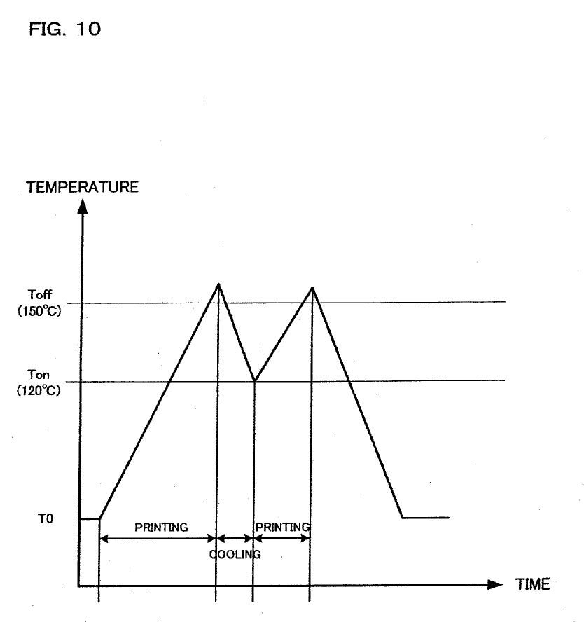

Next, with reference to FIG. 10, a description will be given to a change in temperature of the driver IC 52 during continuous printing on several papers P. In FIG. 10, an axis of ordinate represents a temperature T of the driver IC 52 detected by the temperature detector 65, an axis of abscissa represents time, and T0 represents an initial temperature of the driver IC 52 in a standby state.

As shown in FIG. 10, when printing is continuously performed on several papers P, a temperature T of the driver IC 52 gradually increases only during the printing operation. When the temperature T of the driver IC 52 exceeds the maximum temperature Toff, the stopper 66 stops driving of the driver IC 52. At this time, the placement controller 69 makes the paper P wait at the printing standby position A, while the conveyance controller 68 drives the conveyor belt 8 at high speed. Driving the conveyor belt 8 at high speed makes the passage unit 9 cooled down as described above. Thereby, the driver IC 52 which is thermally coupled with the passage unit 9 is efficiently cooled. When the temperature T becomes the restart temperature Ton, the restarter 67 restarts driving of the driver IC 52, and the conveyance controller 68 drives the conveyor belt 8 in the normal mode. The printing operation is repeated until all printing is completed.

In this embodiment, as thus far described above, while driving of the driver IC 52 is being stopped by the stopper 66 as a result of the temperature T of the driver IC 52 becoming equal to or higher than the maximum temperature Toff, the conveyance controller 68 keeps driving the conveyor belt 8 to thereby cause an airflow around the passage unit 9 of the ink-jet head 1, so that the driver IC 52 is efficiently cooled down. As a consequence, in order to cool down the driver IC 52, printing has to be stopped for a shorter period of time. Therefore, speedup of printing can be realized.

While driving of the driver IC 52 is being stopped by the stopper 66, the placement controller 69 places a next paper P to be placed, at the printing standby position A. Accordingly, when the temperature T of the driver IC 52 reaches the restart temperature Ton and printing is restarted, the paper P can be quickly placed onto the outer circumferential surface 8a of the conveyor belt 8. Therefore, further speedup of printing can be realized.

The grooves 8c are formed on the outer circumferential surface 8a of the conveyor belt 8. Accordingly, when the conveyor belt 8 is driven, a powerful airflow occurs around the passage unit 9, which can cool down the driver IC 52 more efficiently.

The grooves 8c extend from one widthwise end to the other widthwise end of the conveyor belt 8. Accordingly, when the conveyor belt 8 is driven, a more powerful airflow occurs around the passage unit 9, which can cool down the driver IC 52 further more efficiently.

The grooves 8c extend, in the oblique direction against the conveyance direction, from the widthwise center C to the both widthwise ends of the conveyor belt 8. Accordingly, when the conveyor belt 8 is driven, air flows from a longitudinal center toward both longitudinal ends of the ink-jet heads 1. As a consequence, heat staying near the center of the ink-jet head 1 is dissipated toward the both ends, which can cool down the driver IC 52 still further more efficiently.

All of the side cover 53, the passage unit 9, and the reservoir unit 71 are made of a metal having a high thermal conductivity, and in addition the driver IC 52 is thermally coupled with the side cover 53, the passage unit 9, and the reservoir unit 71. As a consequence, heat of the driver IC 52 is dissipated to outside through the side cover 53, the passage unit 9, and the reservoir unit 71. Therefore, the driver IC 52 can be cooled down more efficiently.

While driving of the driver IC 52 is being stopped as a result of temperature T of the driver IC 52 becoming equal to or higher than the maximum temperature Toff, the conveyance controller 68 drives the conveyor belt 8 at a speed higher than in a printing operation, that is, drives the conveyor belt 8 at high speed. As a consequence, a more powerful airflow occurs around the passage unit 9 of the ink-jet head 1, which can cool down the driver IC 52 further more efficiently.

It may not always be necessary that the conveyor belt 8 is driven at high speed while driving of the driver IC 52 is being stopped by the stopper 66 as a result of the temperature T of the driver IC 52 becoming equal to or higher than the maximum temperature Toff. The conveyor belt 8 may be driven also in the normal mode for example. In such a case as well, the driver IC 52 can similarly be cooled down due to an airflow caused by driving of the conveyor belt 8.

In the above-described embodiment, while driving of the driver IC 52 is being stopped by the stopper 66, the placement controller 69 makes a next paper P to be placed wait at the printing standby position A. However, this is not limitative, as long as a paper P is not conveyed on the conveyor belt 8 while driving of the driver IC 52 is being stopped by the stopper 66.

The driver IC 52 may not be thermally coupled with all of the side cover 53, the passage unit 9, and the reservoir unit 71. Instead, the driver IC 52 may be thermally coupled with at least one of them, or alternatively may be thermally coupled with none of them.

In the above-described embodiment, printing on one paper P is one unit of driving operation. However, this is not limitative. For example, in a case where one paper P has several print regions that are separated from each other by a margin or margins, printing in one of the print regions may constitute one unit of driving operation. For a serial-type printer in which a recording head scans in a direction perpendicular to a conveyance direction of the paper P, printing for an arbitrary number of scans may constitute one unit of driving operation.

The above-described embodiment adopts the unimorph-type actuator unit 21 including the piezoelectric sheets 141 to 143. However, another actuator may be adopted as long as it applies ejection energy to the pressure chamber 110.

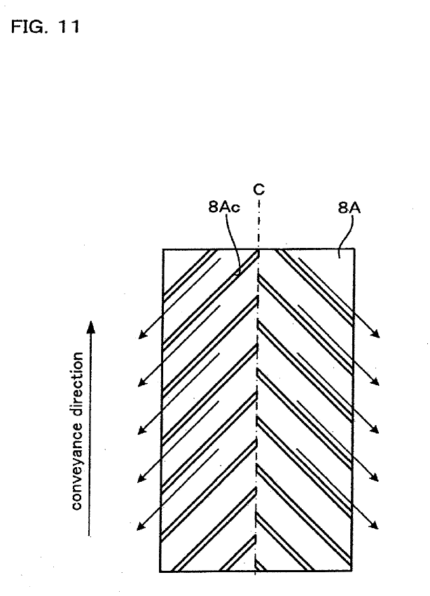

A groove formed on the outer circumferential surface 8a of the conveyor belt 8 is not limited to the V-shaped groove 8c as shown in FIG. 2. For example, a plurality of grooves 8Ac each extending from a center C only to one end may be formed on an outer circumferential surface of a conveyor belt 8A, as shown in FIG. 11. It may be also possible that grooves are formed only near a center C of a conveyor belt. The groove may not necessarily be oblique to the conveyance direction. Besides, the number of grooves formed on an outer circumferential surface of a conveyor belt is not limited. Only one or even no groove may be formed.

The above-described ink-jet printer 101 is a line printer having the immovable heads 1. However, the present invention is applicable to a serial printer whose head moves reciprocatingly. Moreover, the present invention is applicable also to a recording apparatus of another type that generates heat when driven, such as a printer having a thermal head for thermal-transferring ink to a paper P.

Applications of the present invention are not limited to a printer. The present invention is applicable to facsimile machines, copying machine, and other various recording apparatuses.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A recording apparatus comprising:
a conveyor mechanism having a plurality of rollers, an endless conveyor belt which is stretched between the rollers and holds a recording medium on its outer circumferential surface, and a driver which drives the conveyor belt;
a recording head having a head main body which forms an image on the recording medium conveyed by the conveyor mechanism, a driver IC which drives the head main body, and a temperature sensor which detects a temperature of the driver IC;
a stopper which stops driving of the driver IC in a case where the temperature sensor has detected a temperature equal to or higher than a predetermined maximum temperature;
a restarter which restarts driving of the driver IC in a case where, after the stopper stops driving of the driver IC, the temperature sensor has detected a temperature equal to or lower than a predetermined restart temperature; and
a conveyance controller which controls the driver so as to keep driving the conveyor belt while driving of the driver IC is being stopped by the stopper.

2. The recording apparatus according to claim 1, further comprising:
a container which contains the recording medium;
a placer which takes the recording medium out of the container and places the recording medium onto the outer circumferential surface of the conveyor belt; and
a placement controller which controls the placer,
wherein the placement controller controls the placer so as to make the recording medium taken out of the container wait at a position near the conveyor belt while driving of the driver IC is being stopped by the stopper, and to place the recording medium onto the outer circumferential surface of the conveyor belt when driving of the driver IC is restarted by the restarter.

3. The recording apparatus according to claim 1, wherein one or more grooves are formed on the outer circumferential surface of the conveyor belt.

4. The recording apparatus according to claim 3, wherein the groove extends from one widthwise end to the other widthwise end of the conveyor belt.

5. The recording apparatus according to claim 3, wherein:
the recording head extends along a widthwise direction of the outer circumferential surface of the conveyor belt; and
the groove extends from a widthwise center to one widthwise end of the outer circumferential surface of the conveyor belt, in an oblique direction against a driving direction of the conveyor belt.

6. The recording apparatus according to claim 1, wherein:
the recording head includes
a passage unit which is formed therein with a common ink chamber and a plurality of individual ink passages each extending from the common ink chamber through a pressure chamber to a nozzle,
a reservoir unit which temporarily stores therein ink to be supplied to the common ink chamber, and
an actuator which has an individual electrode corresponding to the pressure chamber, a ground electrode given a reference potential, and a piezoelectric layer positioned between the individual electrode and the ground electrode; and
the driver IC is thermally coupled with at least either one of the passage unit and the reservoir unit, and outputs a drive signal to the individual electrode to thereby drive the actuator.

7. The recording apparatus according to claim 6, wherein the passage unit and the reservoir unit are made of a thermally-conductive material.

8. The recording apparatus according to claim 1, wherein the recording head further has a cover which covers the driver IC and is thermally coupled with the driver IC.

9. The recording apparatus according to claim 1, wherein, while driving of the driver IC is being stopped by the stopper, the conveyance controller controls the driver so as to drive the conveyor belt at a speed higher than while an image is being formed on the recording medium.
